(19) United States
(12) Patent Application Publication
(10) Pub. No.: US 2019/0353765 A1
(43) Pub. Date: Nov. 21, 2019

(54) FISH SPECIES ESTIMATING SYSTEM, AND METHOD OF ESTIMATING FISH SPECIES

(71) Applicant: Furuno Electric Co., Ltd., Nishinomiya (JP)

(72) Inventors: Sadao Sato, Nishinomiya (JP); Daisuke Matsumoto, Nishinomiya (JP); Koya Satoh, Nishinomiya (JP)

(21) Appl. No.: 16/414,458

(22) Filed: May 16, 2019

(30) Foreign Application Priority Data
May 18, 2018 (JP) 2018-096081

(51) Int. Cl. G01S 7/539; G01S 15/96; G01S 7/56; G06N 20/00

(52) U.S. Cl. CPC G01S 7/539; G06N 20/00; G01S 7/56; G01S 15/96

(57) ABSTRACT

A fish species estimating system may include an acquiring module and a reasoning module. The acquiring module may acquire a data set at least including echo data generated from a reflected wave of an ultrasonic wave emitted underwater. The reasoning module may estimate a fish species of a fish image included in the echo data of the data set acquired by the acquiring module, by using a learned model created by machine learning where the data set is used as input data and the fish species is used as teacher data.

### CROSS-REFERENCE TO RELATED APPLICATION(S)

This application claims priority under 35 U.S.C. § 119 to Japanese Patent Application No. 2018-096081, which was filed on May 18, 2018, the entire disclosure of which is hereby incorporated by reference.

### TECHNICAL FIELD

The present disclosure relates to fish species estimating system, a method of estimating fish species, and a program.

### BACKGROUND

Since the management of a fish catch has been increasingly strict in the field of fishing every year, a further improvement in accuracy of the technology of estimating the fish species before catching is demanded.

### SUMMARY

The purpose of the present disclosure is to provide a fish species estimating system, a method of estimating fish species, and a program, which can improve accuracy of a fish species estimation.

According to one aspect of the present disclosure, a fish species estimating system may include an acquiring module and a reasoning module. The acquiring module may acquire a data set at least including echo data generated from a reflected wave of an ultrasonic wave emitted underwater. The reasoning module may estimate a fish species of a fish image included in the echo data of the data set acquired by the acquiring module, by using a learned model created by machine learning where the data set is used as input data and the fish species is used as teacher data.

According to another aspect of the present disclosure, a method of estimating a fish species may include acquiring a data set at least including echo data generated from a reflected wave of an ultrasonic wave emitted underwater, and estimating a fish species of a fish image included in the echo data of the acquired data set, by using a learned model created by machine learning where the data set is used as input data and the fish species is used as teacher data.

According to still another aspect of the present disclosure, a program may cause a computer to acquire a data set at least including echo data generated from a reflected wave of an ultrasonic wave emitted underwater, and estimate a fish species of a fish image included in the echo data of the acquired data set, by using a learned model created by machine learning where the data set is used as input data and the fish species is used as teacher data.

### BRIEF DESCRIPTION OF DRAWINGS

The present disclosure is illustrated by way of example and not by way of limitation in the figures of the accompanying drawings, in which like reference numerals indicate like elements and in which:

FIG. 1 is a block diagram illustrating one example of a configuration of a fish species estimating system according to one embodiment;

FIG. 2 is a view illustrating one example of an echo image;

FIG. 3 is a block diagram illustrating a learning phase of a school-of-fish learning/reasoning module;

FIG. 4 is a flowchart illustrating one example of a procedure of the learning phase of the school-of-fish learning/reasoning module;

FIG. 5 is a block diagram illustrating a reasoning phase of the school-of-fish learning/reasoning module;

FIG. 6 is a flowchart illustrating one example of a procedure of the reasoning phase of the school-of-fish learning/reasoning module;

FIG. 7 is a view illustrating one example of a detected fish species database;

FIG. 8 is a block diagram illustrating one example of a configuration of a fish finder;

FIG. 9 is a flowchart illustrating one example of a procedure of a display control;

FIG. 10 is a view illustrating one example of a mark table;

FIG. 11 is a view illustrating one example of an echo image to which a mark is added;

FIG. 12 is a view illustrating another example of the echo image to which the mark is added;

FIG. 13 is a view illustrating one example of a nautical chart image to which the mark is added; and

FIG. 14 is a flowchart illustrating one example of a procedure of a fish species notification.

### DETAILED DESCRIPTION

Hereinafter, one embodiment of the present disclosure will be described with reference to the accompanying drawings. Note that the following embodiment illustrates a method and device for implementing the technical idea of the present disclosure, and the technical idea of the present disclosure is not intended to be limited to the following method and device. The technical idea of the present disclosure may be variously changed or modified within the technical scope of the present disclosure which is defined in the appended claims.

### [System Configuration]

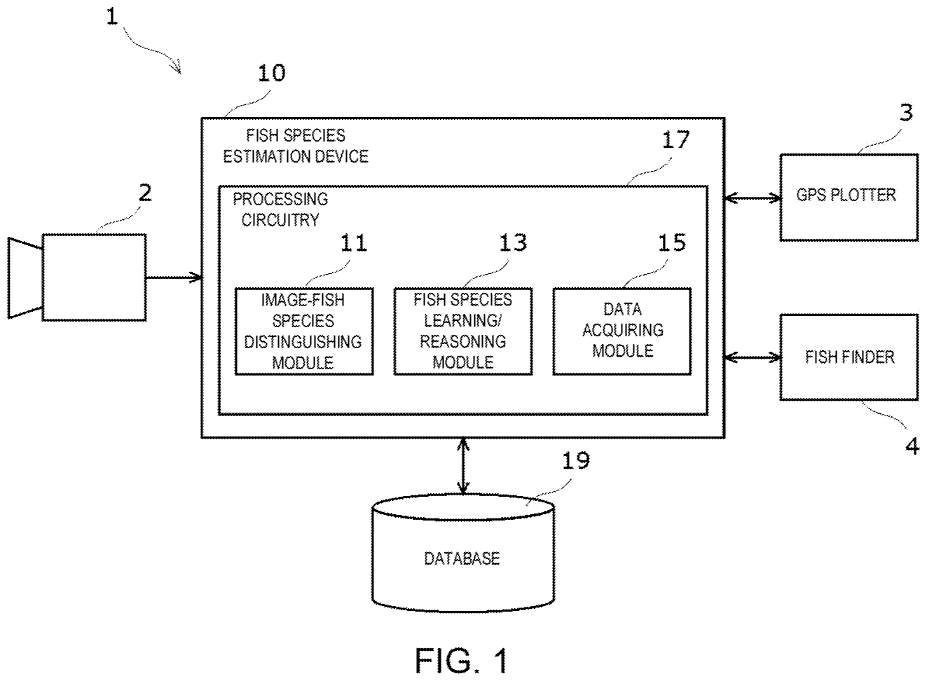

FIG. 1 is a block diagram illustrating one example of a configuration of a fish species estimating system 1 according to one embodiment. The fish species estimating system 1 may include a fish species estimation device 10, a camera 2, a GPS plotter 3, a fish finder 4, and a database 19.

The fish species estimation device 10, the camera 2, the GPS plotter 3, the fish finder 4, and the database 19 included in the fish species estimating system 1 are mounted, for example, on a ship, such as a fishing boat. Without limiting to this configuration a part or all of functions of the fish species estimation device 10 may be realized by a server device installed on the land, for example.

The fish species estimation device 10 may be a computer provided with a processing circuitry 17 including a CPU, a RAM, a ROM, a nonvolatile memory, and an input/output interface. The processing circuitry 17 may include an image-fish species distinguishing module 11, a fish species learning/reasoning module 13, and a data acquiring module 15. These functional modules may be realized by the CPU of the processing circuitry 17 executing information processing according to a program loaded to the RAM from the ROM or the nonvolatile memory. The program may be provided, for example, through an information storage medium, such as an optical disc or a memory card, or may be provided, for example, through a communication network, such as the Internet.

The fish species estimation device 10 may be accessible to the database 19. The database 19 may be realized in the fish species estimation device 10, or may be realized in the GPS plotter 3 or the fish finder 4, or may be realized in the server device installed on the land, etc.

The camera 2 may image fish when or after it is caught to generate image data. For example, the camera 2 may image fish caught in a net when the net is raised, or may image fish raised on the deck, or may image fish put in a fish tank, or may image fish which is landed. The image data generated by the camera 2 may be outputted to the fish species estimation device 10, and it may be used for a learning phase of the fish species learning/reasoning module 13 via the image-fish species distinguishing module 11, as will be described later.

The GPS plotter 3 may generate position data indicative of the current position of the ship based on electric waves received from the GPS (Global Positioning System) and plots the current position of the ship on a nautical chart image displayed on a display unit (not illustrated). The position data generated by the GPS plotter 3 may be outputted to the fish species estimation device 10, and it may be used for the learning phase and a reasoning phase of the fish species learning/reasoning module 13, as will be described later.

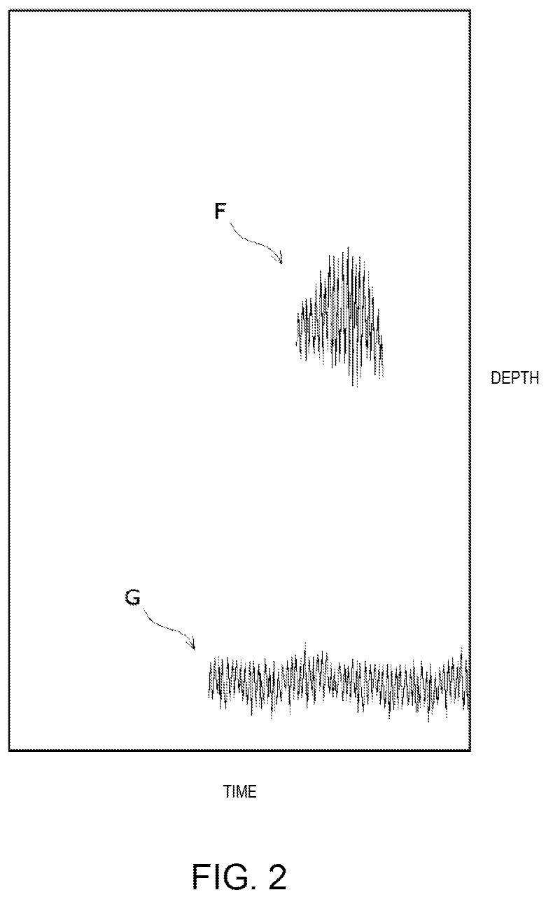

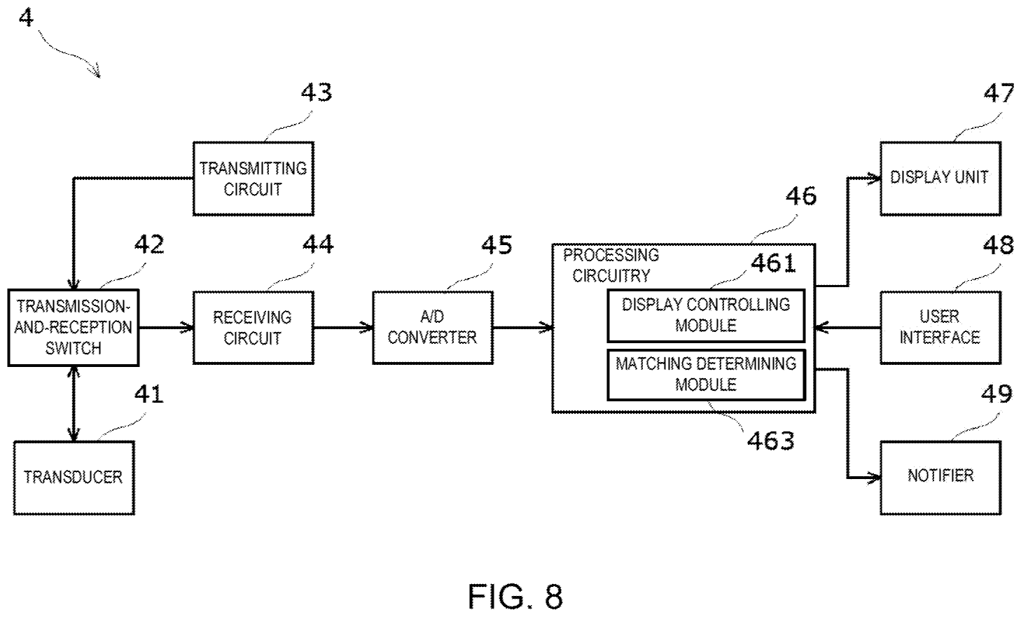

The fish finder 4 may generate echo data from a reflected wave of an ultrasonic wave emitted underwater, and display an echo image based on the echo data on a display unit 47 (refer to FIG. 8). The concrete configuration of the fish finder 4 will be described later. As illustrated in the example of FIG. 2, the echo image may include a fish image F indicative of a component reflected on underwater fish, and a waterbed or seabed image G indicative of a component reflected on the waterbed or seabed.

Further, the fish finder 4 may detect water depth data based on the echo data and detects water temperature data by a temperature sensor. The echo data, the water depth data, and the water temperature data which are generated by the fish finder 4 may be outputted to the fish species estimation device 10, and they may be used for the learning phase and the reasoning phase of the fish species learning/reasoning module 13, as will be described later.

The image data from the camera 2, the position data from the GPS plotter 3, the echo data, the water depth data, the water temperature data from the fish finder 4, etc. may be acquired by the data acquiring module 15, and they may be stored in the database 19.

Among these, a data set including the echo data, the position data, the water depth data, and the water temperature data may be used as input data of the fish species learning/reasoning module 13. The data set may be stored at every given time. The data set may at least include the echo data, and one or more of the position data, the water depth data and the water temperature data may be omitted, or the data set may further include other data, such as time and/or day data, and tidal current data.

The image data may be used as input data of the image-fish species distinguishing module 11. The image data may be stored so as to be associated with the data set acquired before catching fish. Specifically, the image data may be associated with the data set so that fish imaged by the camera 2 matches with fish detected by the echo data. For example, they may be associated with each other automatically in consideration of the time required for catching the fish, or may be associated with each other, or manually by a user.

For example, the position when the fish finder 4 detects a school of fish may be stored, and the image data and the data set may be associated with each other, when satisfying a condition that a distance between the position when the school of fish (signs of fish) is detected and the position when the school of fish is caught (i.e., the position where the image data is generated) is below a threshold. A condition that a difference between the time at which the school of fish is detected and the time at which the school of fish is caught is below a threshold may be further combined with the condition described above. The position at which the school of fish is caught is, for example, the position of the ship when the fish is caught if it is fishing with a fishing pole, and the starting position of hauling a net or the center position of the net, if it is fishing with a round haul net.

The image-fish species distinguishing module 11 is one example of a distinguishing module. When the image data is inputted, the image-fish species distinguishing module 11 may distinguish a fish species of a fish image included in the image data, and output it. The fish species outputted from the image-fish species distinguishing module 11 may be used as a teacher data in the learning phase of the fish species learning/reasoning module 13, as will be described later. The fish species may be distinguished beforehand and stored in the database 19 so as to be associated with the data set as well as the image data, or may be distinguished during the learning phase of the fish species learning/reasoning module 13 and directly inputted into the fish species learning/reasoning module 13.

In this embodiment, the image-fish species distinguishing module 11 may be a learning/reasoning module which realizes a learning phase and a reasoning phase by machine learning, similar to the fish species learning/reasoning module 13. Specifically, the image-fish species distinguishing module 11 may create a learned model by the machine learning in the learning phase, using the image data as input data and the fish species as the teacher data. The fish species as the teacher data is inputted, for example, by the user. Moreover, the image-fish species distinguishing module 11 may use the learned model created in the learning phase, estimate in a reasoning phase the fish species of the fish image included in the image data by using the image data as the input data, and output the fish species.

Without limiting to the configuration described above, the image-fish species distinguishing module 11 may omit the part which realizes the learning phase and may only be comprised of the part which realizes the reasoning phase. Alternatively, the image-fish species distinguishing module 11 may distinguish the fish species of the fish image included in the image data by an image recognition technology which extracts feature(s) from the image data to identify an object without using the learned model created by the machine learning.

The fish species learning/reasoning module 13 is one example of the learning module and the reasoning module, and may realize the learning phase and the reasoning phase by the machine learning. Specifically, the fish species learning/reasoning module 13 may create in the learning phase the learned model by the machine learning by using the data set including the echo data etc. as the input data, and the fish species distinguished by the image-fish species distinguishing module 11 as the teacher data. Moreover, the fish species learning/reasoning module 13 may use the learned model created in the learning phase, estimate in the reasoning phase the fish species of the fish image included in the echo data by using the data set including the echo data etc. as the input data, and output the fish species.

The machine learning may use, for example, a neural network. Particularly, deep learning using a deep neural network where multiple layers of neurons are combined may be suitable. Without limiting to the configuration described above, machine learning other than the neural network, such as a support vector machine, a decision tree, etc. may be used.

Note that, since the part which realizes the learning phase in the image-fish species distinguishing module 11 and the fish species learning/reasoning module 13 requires a high calculation throughput, it may be realized by a server device installed on the land, etc. In such a case, data may be communicated sequentially using satellite communication etc., or data may be stored while the ship is traveling and the data may be communicated all at once when the ship returns to a port.

### [Learning Phase]

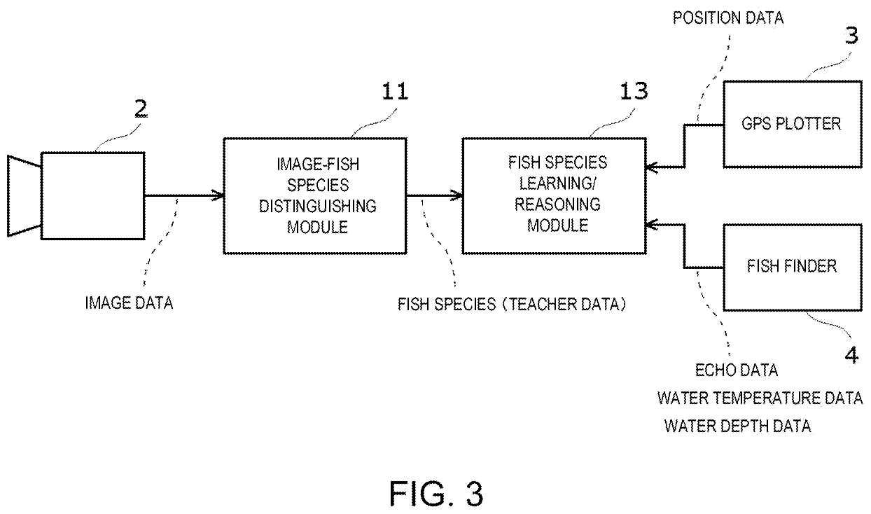

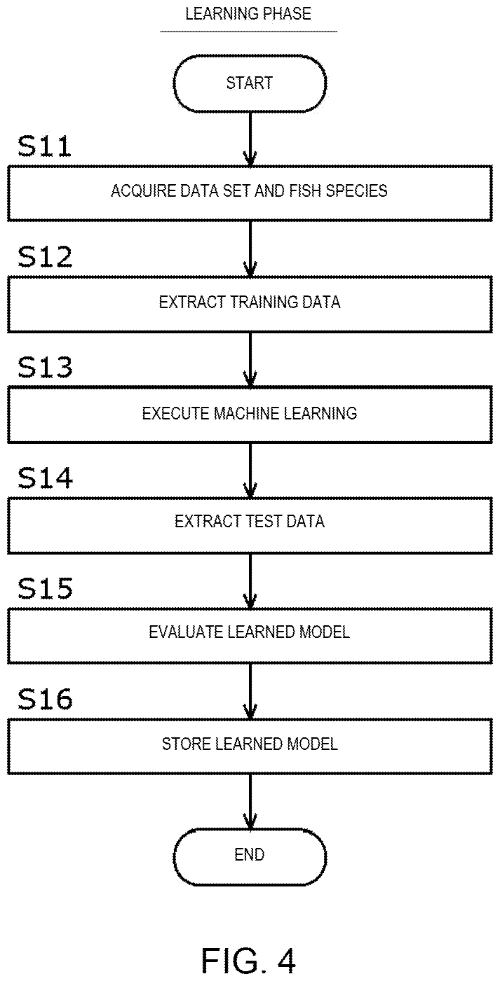

FIG. 3 is a block diagram illustrating the learning phase of the fish species learning/reasoning module 13. FIG. 4 is a flowchart illustrating one example of a procedure of the learning phase of the fish species learning/reasoning module 13.

First, the fish species learning/reasoning module 13 may acquire the data set and the fish species (S11). In the learning phase, the data set and the fish species associated with the data set may be read from the database 19. The data set may include the position data from the GPS plotter 3, and the echo data, the water depth data, and the water temperature data from the fish finder 4, etc. The fish species may be distinguished by the image-fish species distinguishing module 11 based on the image data from the camera 2. The fish species may be read from the database 19 or may be directly inputted from the image-fish species distinguishing module 11.

Note that, although arrows indicate a flow of the data in FIG. 3 for convenience of explanation, each data may be, in fact, stored in the database 19 and read from the database 19. Without limiting to this configuration, each data may be directly inputted and outputted, without the intervening database 19.

Next, the fish species learning/reasoning module 13 may extract a part of a plurality of groups of data sets and fish species, as training data for the machine learning (S12), and execute the machine learning using the extracted training data (S13). The machine learning may be performed using the data set as the input data and the fish species as the teacher data. Thus, the learned model for estimating the fish species of the fish image included in the echo data may be created.

Next, the fish species learning/reasoning module 13 may extract a part different from the training data from the plurality of groups of the data set and the fish species, as test data (S14), and evaluate the learned model using the extracted test data (S15). Then, the fish species learning/reasoning module 13 may store in the database 19 the learned model(s) for which the evaluation is satisfactory (S16), and then end the learning phase.

### [Reasoning Phase]

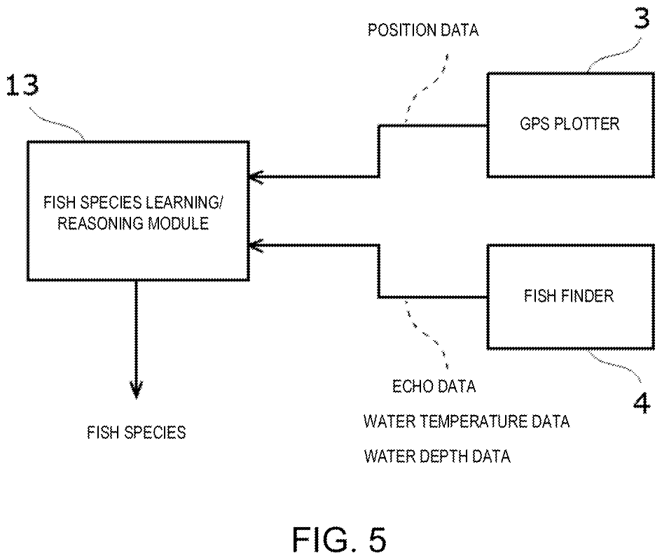

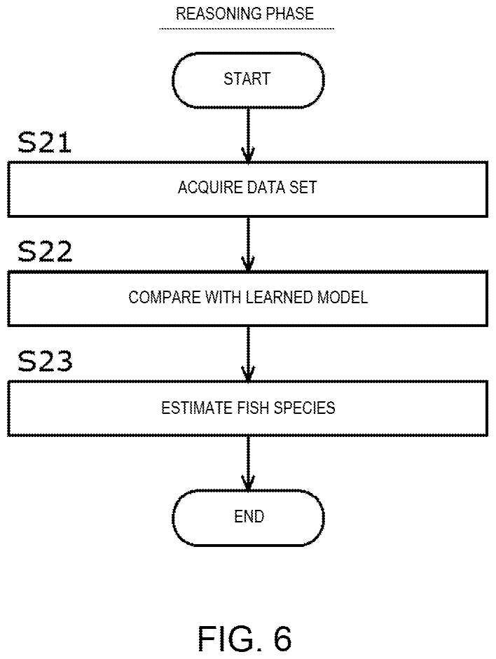

FIG. 5 is a block diagram illustrating the reasoning phase of the fish species learning/reasoning module 13. FIG. 6 is a flowchart illustrating one example of a procedure of the reasoning phase of the fish species learning/reasoning module 13.

First, the fish species learning/reasoning module 13 may acquire a data set (S21, processing as an acquiring module). In the reasoning phase, the echo data, the position data, the water depth data, the water temperature data, etc. which are included in the data set may be directly inputted into the fish species learning/reasoning module 13 from the GPS plotter 3 and the fish finder 4. Without limiting to this configuration, the data set may once be stored in the database 19, and may be read from the database 19.

Next, the fish species learning/reasoning module 13 may use the data set including the acquired echo data as the input data, compare the input data with the learned model created in the learning phase (S22), and estimate and output the fish species of the fish image included in the echo data (S23). The comparison with the learned model may be, for example, pattern matching of the echo image based on the echo data with the learned model image. The fish species estimated by the fish species learning/reasoning module 13 may be outputted to the database 19, the GPS plotter 3, and the fish finder 4, etc.

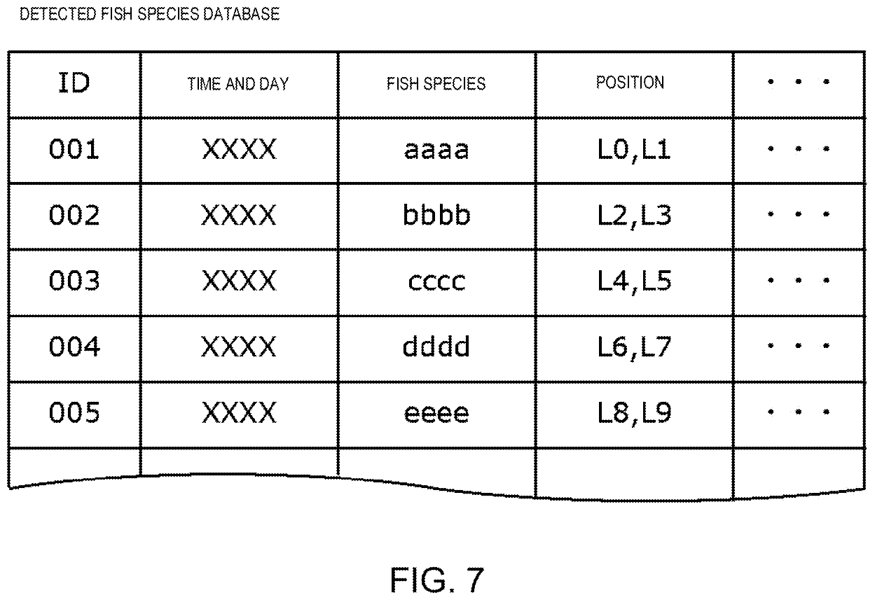

As illustrated in FIG. 7, the fish species outputted from the fish species learning/reasoning module 13 is, for example, stored in a detected fish species database included in the database 19 so as to be associated with the time and/or day data, the position data, etc. Further, the fish species may be, for example, associated with the data, such as the water depth data, the water temperature data, the current data, etc.

According to the above embodiment, it is possible to improve the accuracy of the fish species estimation by using the learned model created by the machine learning and estimating the fish species of the fish image included in the echo data. Moreover, it is possible to further improve the accuracy of the fish species estimation by repeating the machine learning using the data set and the fish species which are acquired each time fish is caught.

Moreover, according to the above embodiment, since the fish species distinguished by the image-fish species distinguishing module 11 based on the image data is used as the teacher data in the learning phase of the fish species learning/reasoning module 13, it becomes possible to omit the user's burden for inputting the fish species, thereby improving the accuracy of the fish species estimation, while reducing the user's burden.

Note that, although in the above embodiment only the fish species is treated as the property to be distinguished and estimated, the fish species and fish quantity may be used as the properties to be distinguished by the image-fish species distinguishing module 11, as the teacher data in the learning phase of the fish species learning/reasoning module 13, and as the property to be estimated in the reasoning phase of the fish species learning/reasoning module 13. According to this configuration, since the fish quantity is estimated as well as the fish species, these are further useful for determination of the fish catch.

### [Fish Finder]

FIG. 8 is a block diagram illustrating one example of a configuration of the fish finder 4. The fish finder 4 may include a transducer 41, a transmission-and-reception switch 42, a transmitting circuit 43, a receiving circuit 44, an A/D converter 45, a processing circuitry 46, a display unit 47, a user interface 48, and a notifier 49 (notifying module). The processing circuitry 46 may include a display controlling module 461 and a matching determining module 463.

The transducer 41 may include an ultrasonic transducer and may be installed in the bottom of the ship. The transducer 41 may convert an electrical signal from the transmitting circuit 43 into an ultrasonic wave and transmit the ultrasonic wave underwater, and convert a received reflected wave into an electrical signal and output the electrical signal to the receiving circuit 44. The transmission-and-reception switch 42 may connect the transmitting circuit 43 to the transducer 41 upon the transmission, and connect the receiving circuit 44 to the transducer 41 upon reception.

The receiving circuit 44 may amplify the electrical signal from the transducer 41, and output it to the A/D converter 45. The A/D converter 45 may convert the electrical signal from the receiving circuit 44 into digital data (i.e., echo data), and output it to the processing circuitry 46.

The processing circuitry 46 may be a computer including a CPU, a RAM, a ROM, a nonvolatile memory, and an input/output interface. The functional parts included in the processing circuitry 46 may be realized by the CPU executing information processing according to a program loaded to the RAM from the ROM or the nonvolatile memory. The program may be provided, for example, through information storage medium, such as an optical disc or a memory card, or may be provided, for example, through a communication network, such as the Internet.

The display unit 47 is, for example, a liquid crystal display. The user interface 48 is, for example, a button switch or a touch panel. The notifier 49 is, for example, a speaker or a buzzer.

### [Display Control]

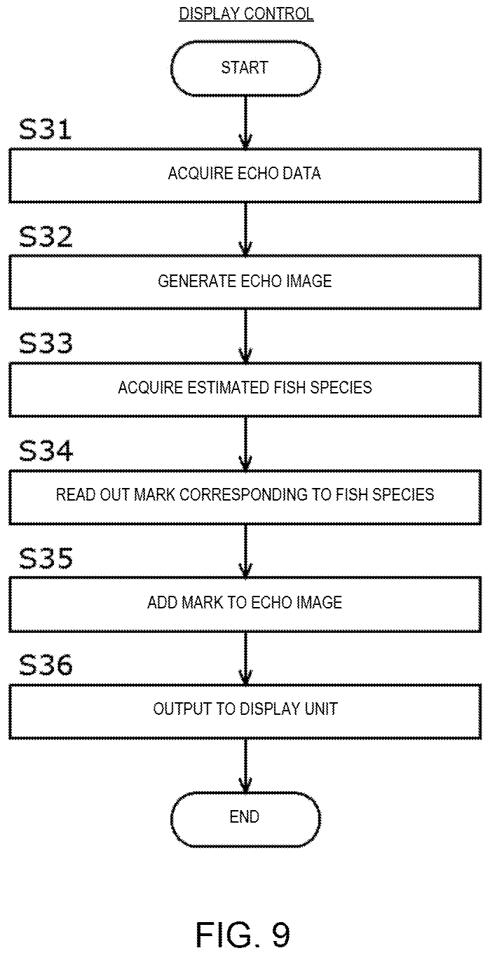

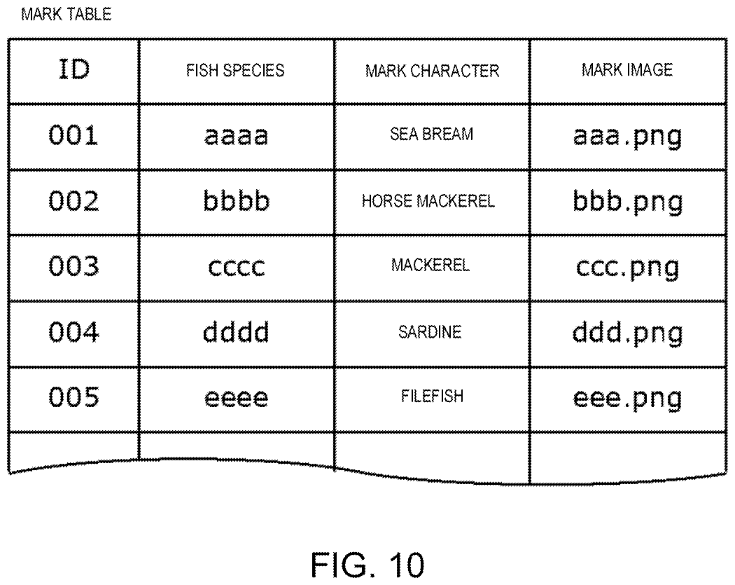

FIG. 9 is a flowchart illustrating one example of a procedure of a display control executed by the processing circuitry 46, in order to realize the display controlling module 461. FIG. 10 is a view illustrating one example of a mark table which is referred when executing the display control.

The processing circuitry 46 may first acquire the echo data from the A/D converter 45 (S31), and then generate the echo image based on the acquired echo data (S32). As illustrated in the example of FIG. 2, the echo image may include the fish image F and the waterbed image G.

Next, the processing circuitry 46 may acquire the estimated fish species from the fish species estimation device 10 (S33).

Next, the processing circuitry 46 may refer to the mark table and read out a mark corresponding to the acquired fish species (S34). As illustrated in the example of FIG. 10, in the mark table, mark characters and a mark image which constitute each mark may be associated with the corresponding fish species. A character string indicative of a fish species is included in a column of the mark characters, and a file name of an image may be included in a column of the mark image. The mark table may be stored in the memory of the processing circuitry 46, or may be stored in the database 19.

Next, the processing circuitry 46 may add the read-out mark to the echo image (S35), and output the echo image attached with the mark to the display unit 47 (S36). Thus, the echo image with the mark may be displayed on the display unit 47.

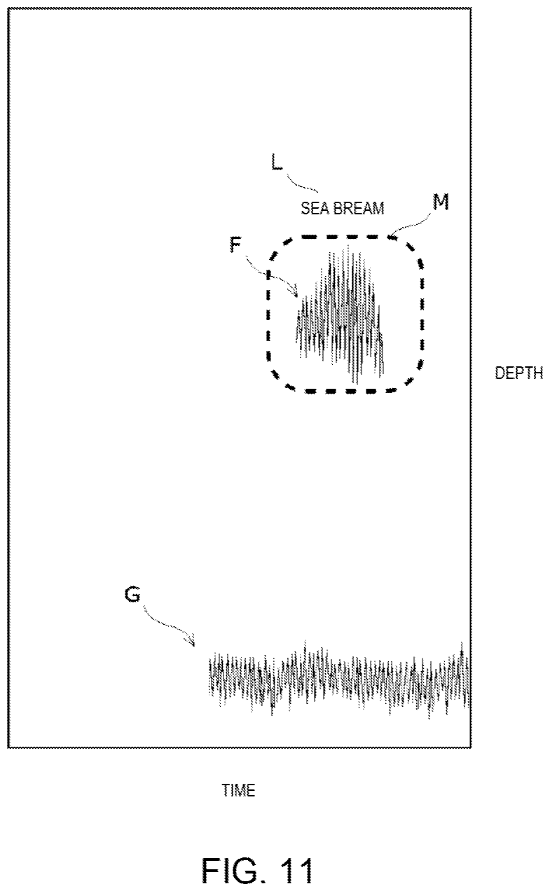

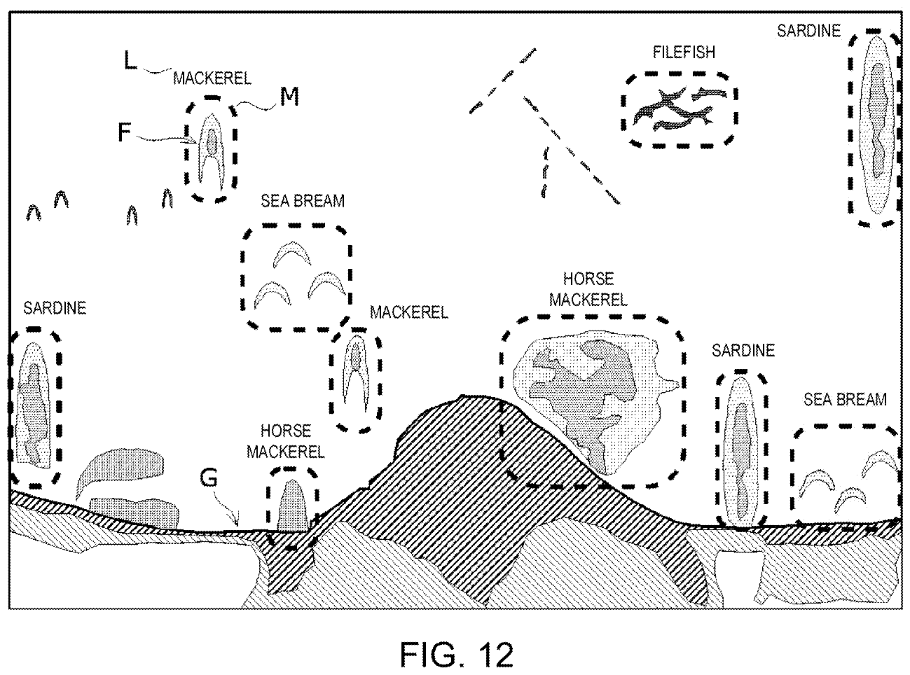

As illustrated in the example of FIG. 11, over the echo image, the mark image M and the mark characters L may be added so as to be associated with the fish image F. In the illustrated example, the mark image M may be an image of an enclosing line, and it may be disposed so that the enclosing line encloses the fish image F. The mark characters L may be disposed near the mark image M. The example of FIG. 12 is an echo image illustrating a larger area than that of FIG. 11. Like this case, when the echo image includes a plurality of fish images F, the mark image M and the mark characters L may be added to each fish image F. The mark image M may be desirable to be in a different color and have a different shape for every fish species in order to facilitate the discrimination.

As described above, since the echo image to which the marks are added is displayed on the display unit 47, the user is able to recognize the fish species of the fish image included in the echo image. Note that, although in this embodiment the fish species estimated by the fish species estimation device 10 is used, the fish species distinguished by the conventional technique disclosed in JP2014-077703A etc. may be used for the addition of marks.

Moreover, the addition of the mark may be performed only for the fish species specified by the user operating the user interface 48. Therefore, it may become easier for the user to recognize a desired fish species. Similarly, the registration to the detected fish species database (refer to FIG. 7) described above may also be performed only when the user operates the user interface 48. Therefore, the user can save the detected fish species after checking the mark displayed on the display unit 47.

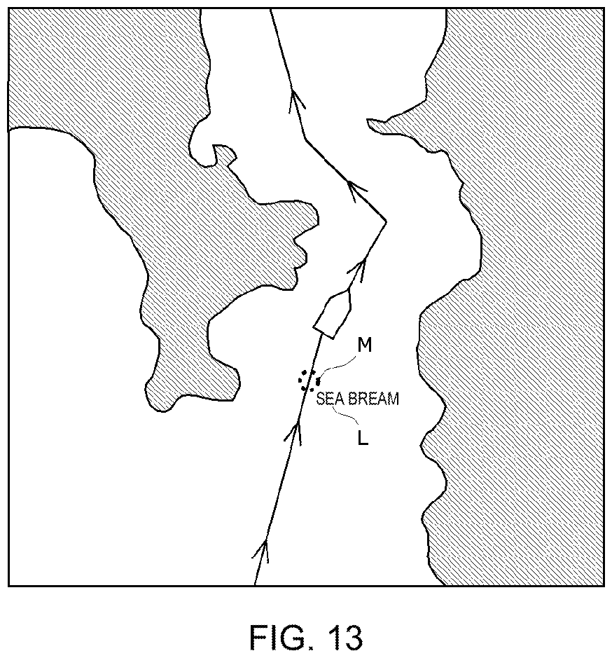

Note that, although in this embodiment one example in which the mark is added to the echo image displayed on the display unit 47 of the fish finder 4 is described, the adding of the mark is not limited to on the display unit 47. For example, as illustrated in the example of FIG. 13, the mark of the mark image M and the mark character L may be added to the nautical chart image displayed on the display unit (not illustrated) of the GPS plotter 3, based on the fish species and the position data which are registered to the detected fish species database (refer to FIG. 7).

### [Fish Species Notification]

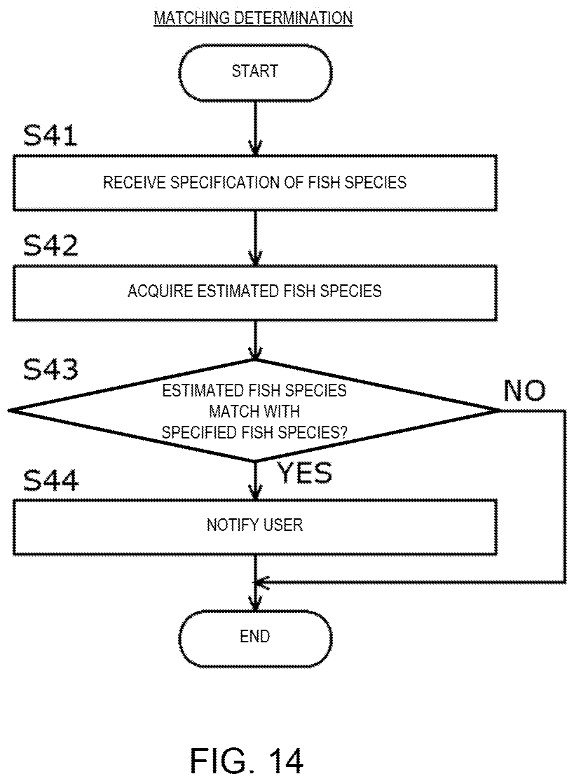

FIG. 14 is a flowchart illustrating one example of a procedure of a fish species notification executed by the processing circuitry 46, in order to realize the matching determining module 463. The processing circuitry 46 may first receive a specification of a fish species from the user (S41). The specification of the fish species is performed by the user operating the user interface 48. Next, the processing circuitry 46 may acquire the fish species estimated from the fish species estimation device 10 (S42).

Next, the processing circuitry 46 may determine whether the estimated fish species matches with the fish species specified by the user (S43). If matched (S43: YES), the processing circuitry 46 may drive the notifier 49 to notify the user that the specified fish species has appeared (S44). The notification may be performed by, for example, voice from the speaker or buzzer.

By performing the notification, it becomes possible for the user to recognize that the specified fish species has appeared.

### <Terminology>

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controlling module, microcontrolling module, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controlling module, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow views described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein are preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A fish species estimating system, comprising:
processing circuitry configured to:
acquire a data set at least including echo data generated from a reflected wave of an ultrasonic wave emitted underwater; and
estimate a fish species of a fish image included in the echo data of the data set, by using a learned model created by machine learning where the data set is used as input data and the fish species is used as teacher data.

2. The fish species estimating system of claim 1, wherein the processing circuitry is further configured to:
distinguish the fish species of the fish image included in image data generated by a camera configured to image fish caught; and
create the learned model by using the distinguished fish species as teacher data.

3. The fish species estimating system of claim 2, wherein the processing circuitry distinguishes the fish species of the fish image included in the image data by using a learned model created by machine learning where the image data is used as input data and the fish species is used as teacher data.

4. The fish species estimating system of claim 2, wherein the processing circuitry associates the image data with the data set, when a distance between a position when signs of fish are detected based on the echo data and a position where the image data is generated is below a threshold.

5. The fish species estimating system of claim 3, wherein the processing circuitry associates the image data with the data set, when a distance between a position when signs of fish are detected based on the echo data and a position where the image data is generated is below a threshold.

6. The fish species estimating system of claim 1, wherein the data set further includes one or more data selected from position data, water temperature data, and water depth data.

7. The fish species estimating system of claim 3, wherein the data set further includes one or more data selected from position data, water temperature data, and water depth data.

8. The fish species estimating system of claim 1, wherein the learned model is created using the fish species and a fish quantity as teacher data, and
wherein the processing circuitry estimates the fish species and the fish quantity of the fish image included in the echo data.

9. The fish species estimating system of claim 3, wherein the data set further includes one or more data selected from position data, water temperature data, and water depth data.

10. The fish species estimating system of claim 1, wherein the processing circuitry is further configured to:
display an echo image based on the echo data, and
add a mark indicative of the estimated fish species to the echo image, so as to be associated with the fish image included in the echo image.

11. The fish species estimating system of claim 3, wherein the processing circuitry is further configured to:
display an echo image based on the echo data, and
add a mark indicative of the estimated fish species to the echo image, so as to be associated with the fish image included in the echo image.

12. The fish species estimating system of claim 1, wherein the processing circuitry is further configured to when the estimated fish species matches with a prespecified fish species, notify a user about the fish species.

13. The fish species estimating system of claim 3, wherein the processing circuitry is further configured to when the estimated fish species matches with a prespecified fish species, notify a user about the fish species.

14. A method of estimating a fish species, comprising:
acquiring a data set at least including echo data generated from a reflected wave of an ultrasonic wave emitted underwater; and
estimating a fish species of a fish image included in the echo data of the acquired data set, by using a learned model created by machine learning where the data set is used as input data and the fish species is used as teacher data.
